(19) United States
(12) Patent Application Publication
(10) Pub. No.: US 2026/0219933 A1
(43) Pub. Date: Jul. 30, 2026

(54) MANAGEMENT OF SYSTEMS OVER LIFETIME

(71) Applicant: Dell Products L.P., Round Rock, TX (US)

(72) Inventor: DHARMESH M. PATEL, Round Rock, TX (US)

(21) Appl. No.: 19/036,303

(22) Filed: Jan. 24, 2025

(51) Int. Cl. G06F 9/50

(52) U.S. Cl. CPC G06F 9/5027

(57) ABSTRACT

Methods, systems, and devices are provided for managing operation of a system. To manage the system, varying performance expectations may be used as a basis for identifying desirable from undesirable operation. The varying performance expectations may take into account the impacts of both time and changes in pipelines used by the system to provide desired services. By proactively taking into account potential changes in the pipeline, the operation of the pipeline may be less likely to be flagged as undesirable when the system is not actually operating in an undesirable manner.

### FIELD

Embodiments disclosed herein relate generally to management of data processing systems. More particularly, embodiments disclosed herein relate to systems and methods for management of artificial intelligence-based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating systems in accordance with an embodiment.

FIGS. 2A-2C and 2F-2G show data flow diagrams illustrating processing of data in accordance with an embodiment.

FIGS. 2D-2E show block diagrams illustrating hardware systems in accordance with an embodiment.

FIGS. 3A-3B show flow diagrams illustrating methods for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer implemented services may be provided to any type and/or number of other devices and/or users of the data processing systems. Furthermore, the provided computer implemented services may be of any quantity and/or type of such services.

As part of the computer implemented services, various artificial intelligence based services may be utilized. To enable artificial intelligence based services to be efficiently provided, potential hardware to support operation of an artificial intelligence based workflow architecture may be analyzed. During the analysis, potential communication bottlenecks may be proactively identified and used as a basis for disqualifying potential hardware.

Consequently, when deployed to selected hardware, the artificial intelligence based services may be less likely to suffer phantom slowdowns or other undesired behavior due to communication bottlenecks that may not be apparent from analysis of the hardware architecture. Accordingly, the disclosed systems may be more likely to provide desired services (e.g., that meet the expectations of users).

Over time, the artificial intelligence workflow pipeline may change due to model updates, model architecture changes, etc. To take such changes into account, performance of the artificial intelligence workflow pipeline may be compared to time varying performance expectations. The time varying performance expectations may take both time and potential changes to the artificial intelligence workflow pipeline to establish different basis for comparison. Consequently, the artificial intelligence workflow pipeline may be less likely to be falsely identified as operating in an undesired manner.

In an embodiment, a method for managing operation of a distributed system is provided. The method may include obtaining time varying performance expectations for artificial intelligence services provided by the distributed system; obtaining metrics for an artificial intelligence workflow pipeline hosted by the distributed system that provides the artificial intelligence services; identifying a subset of the time varying performance expectations based on, at least, the metrics; monitoring operation of the distributed system based on the subset to obtain performance metrics; making a determination regarding whether the performance metrics meet requirements of the subset of the time varying performance expectations; in a first instance of the determination where the performance metrics do not meet the requirements of the subset of the time varying performance expectations: concluding that the artificial intelligence workflow pipeline is in an undesired state; and in a second instance of the determination where the performance metrics meet the requirements of the subset of the time varying performance expectations: concluding that the artificial intelligence workflow pipeline is in a desired state and continuing provisioning of the artificial intelligence services using the artificial intelligence workflow pipeline.

The subset may be indicated by the time varying performance expectations.

At least one portion of the subset may be a quantification of a rate at which the artificial intelligence workflow pipeline services requests.

At least one portion of the subset may be a quantification of a rate at which a support service for the artificial intelligence workflow pipeline services requests.

The method may also include, based on concluding that the artificial intelligence workflow pipeline is in an undesired state: attempting to remediate the artificial intelligence workflow pipeline to place the artificial intelligence workflow pipeline into the desired state.

The time varying performance expectations may include multiple subsets that are each associated with different points in time.

The multiple subsets may indicate progressively relaxed requirements over time.

The different points in time may be measured with reference to an initiation of provisioning of the artificial intelligence services by the distributed system.

The metrics for the artificial intelligence workflow pipeline may include a size of a trained machine learning model of the artificial intelligence workflow pipeline; and a quantity of training data used in training of the trained machine learning model.

The requirements may vary, at least in part, based on the metrics.

In an embodiment, a non-transitory media is provided. The non-transitory media may include instructions that when executed by a processor cause, at least in part, any of the methods discussed above to be performed.

In an embodiment, a data processing system is provided. The data processing system may include the non-transitory media and a processor and may, at least in part, perform any of the methods discussed above when the computer instructions are executed by the processor.

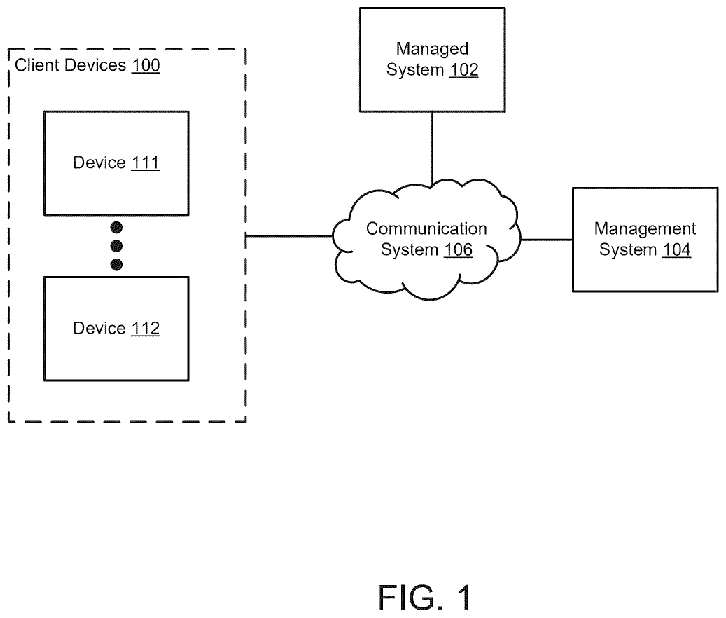

Turning to FIG. 1, a block diagram illustrating a system in accordance with an embodiment is shown. The system shown in FIG. 1 may be a distributed system that provides computer implemented services.

These computer implemented services may include any type and/or quantity of services. The services may include, for example, database services, data processing services, electronic communication services, and/or any other services that may be provided by one or more computing devices. Other types of services may be provided by the system shown in FIG. 1 without departing from embodiments disclosed herein.

When providing these computer implemented services, other types of services (e.g., non-primary services) may be utilized (e.g., by primary services that provide the desired computer implemented services). For example, various artificial intelligence based services (e.g., non-primary services) may be used to provide the desired computer implemented services (e.g., by primary services). The artificial intelligence based services may be provided using, for example, trained machine learning models. The trained machine learning models may be trained to provide inferential, generative, and/or other types of artificial intelligence based services.

In the context of generative services, various prompts may be submitted and processed by the trained machine learning models to generate an output. Depending on the type of the generative services, various other supporting services such as retrieval augmented generation, transfer learning, distillation, reinforced learning, and/or other support services for artificial intelligence services may be used. Consequently, an artificial intelligence based processing architecture (e.g.., trained machine learning model and other support services) may vary significantly depending on implementation.

To support operation of the artificial intelligence based processing architectures, various hardware resources may be allocated for use by these artificial intelligence based processing architectures. However, unlike many types of computing processes that may generally benefit from resource scaling (e.g., allocating additional computing resources via any mechanism such as parallelism via instantiating new instances of components of the artificial intelligence based processing architectures), artificial intelligence based processing architectures may present unique resource constraints that may result in unexpected behavior when resource scaling is employed. If the unique resource constraints (or other types of limits) are not met by the resources allocated to the artificial intelligence based processing architectures, then the additionally allocated resources may be used inefficiently and the artificial intelligence based processing architectures may provide poor quality of services. For example, various bottlenecks in the allocated resources may prevent the artificial intelligence based processing architectures from efficiently utilizing the allocated resources. Consequently, significant quantities of allocated resources may go unutilized (or underutilized) because other resources (or lack thereof) may be constraining operation of the artificial intelligence based processing architectures. Thus, artificial intelligence based processing architecture may inefficiently utilize allocated computing resources.

In general, embodiments disclosed herein relate to systems, devices, and methods for managing operation of a distributed system that provides, in part, artificial intelligence based computer implemented services in a manner that improves efficiency of use of allocated resources (e.g., computing resource such as hardware components or logical allocations of resources provided by hardware components such as processing cycles, memory space, storage space, communication bandwidth, special purpose processing cycles, etc., and/or instance based scaling). To manage the operation of the system, hardware components to support services provided by the system may be selected based on artificial intelligence based processing architectures that are expected to be used to provide the services.

To select the hardware components, information regarding expected services to be provided (e.g., a goal description and/or supplemental description) may be collected and analyzed to estimate use levels for the services, support levels for the services, and model levels for the services. The aforementioned information may be analyzed to identify (i) an artificial intelligence based processing architecture and (ii) corresponding hardware components usable to support the identified artificial intelligence based processing architecture.

During the aforementioned analysis, communication requirements between components of the artificial intelligence based processing architecture may be used to screen, filter, and/or otherwise discriminate undesirable hardware components (or entire architectures) from desirable hardware components (or entire architectures). For example, hardware components may be analyzed with respect to communication bottlenecks that are likely to be created between components of artificial intelligence based processing architectures. These bottlenecks (and/or other information regarding communication limits) may be used as a basis for discriminating undesirable from desirable hardware components.

Once the hardware components (e.g., in aggregate a selected architecture) are identified, the identified hardware components may be used to update operation of a system to provide the desired computer implemented services. For example, new hardware components may be added and/or existing hardware components may be repurposed for providing the desired computer implemented services.

To manage expectations regarding the to-be-provided services, time varying performance expectations may be established. The time varying performance expectations may serve to discriminate acceptable behavior from unacceptable behavior. For example, the time varying performance expectations may include any number of subsets of requirements that vary over time. Further, the subsets of the requirements may each have some dependence on the artificial intelligence workflow pipeline used to provide the services. By taking these factors into account, an operator of an artificial intelligence system may be better able to gauge whether the artificial intelligence workflow pipeline and host hardware is operating acceptably.

To provide the above noted functionality, the system of FIG. 1 may include client devices 100, managed system 102, management system 104, and communication system 106. Each of these is discussed below.

Client devices 100 may include any number of data processing systems such as devices 111 and 112. Devices 111-112 may be, for example, personal computers issued by an organization to an employee, or another type of computing device. Any of client devices 100 may provide any number and type of computer implemented services to users thereof and/or other devices. As part of providing the services, client devices 100 may utilize services provided by managed system 102. The services may include, for example, artificial intelligence based processing services using artificial intelligence based processing architectures hosted by managed system 102.

Managed system 102 may provide various services to client devices 100 (and/or other devices/entities). To do so, managed system may (i) include hardware and software components corresponding to desired services as indicated by the users (or administrators) of client devices 100, and (ii) host artificial intelligence based processing architectures used to provide, at least in part, the services to client devices 100. Managed system 102 may include any number and type of data processing systems. The data processing systems may independently and/or cooperatively provide various computer implemented services.

Management system 104 may manage operation of managed system 102 on behalf of users (or administrators) of client devices 100. To do so, management system 104 may (i) provide a portal or other interface through which users/administrators of client devices 100 may indicate services that are to be provided by managed system 102 (e.g., to client devices 100 and/or other devices not shown in FIG. 1), (ii) select hardware/software components to provide the services (e.g., based on artificial intelligence based processing architectures), (iii) when selecting the components, perform various communication capabilities analysis and reviews to discriminate desirable from undesirable hardware components to support an artificial intelligence based processing architecture, (iv) modify the hardware components (e.g., add/remove/reconfigure/reallocate for use in the identified services) and/or the operation of managed system 102 (e.g., by adding/removing/reconfiguring software components) over time (e.g., based on information from users/administrators of client devices 100 and/or other basis), and/or perform other actions to facilitate provisioning of services by managed system 102.

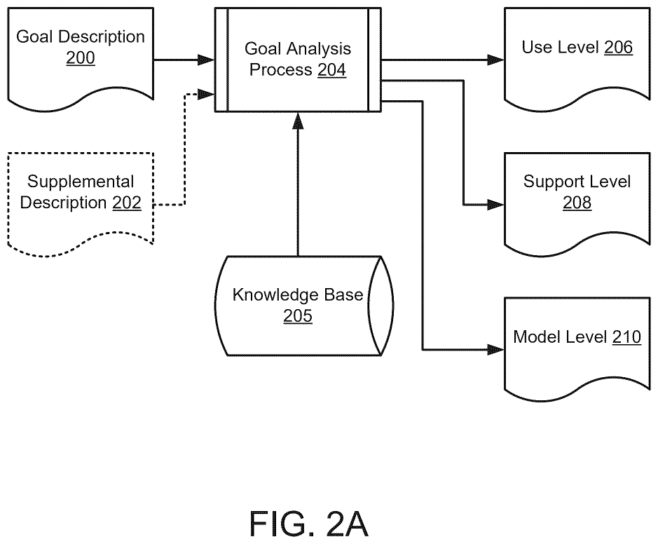

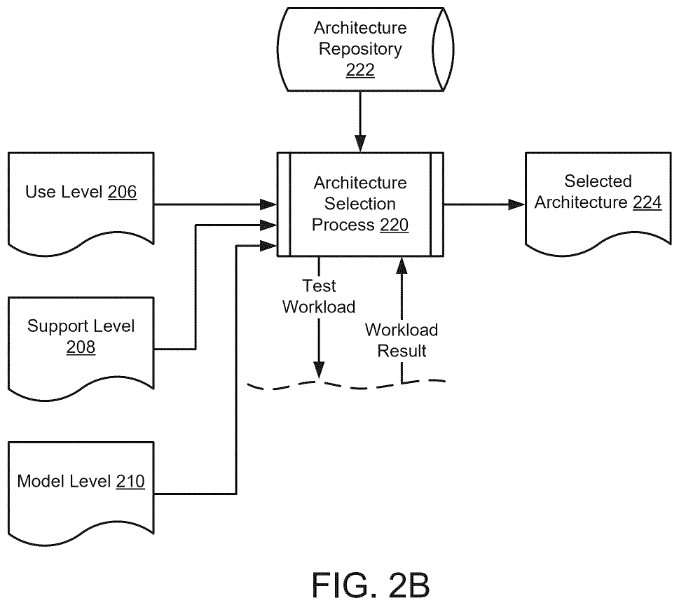

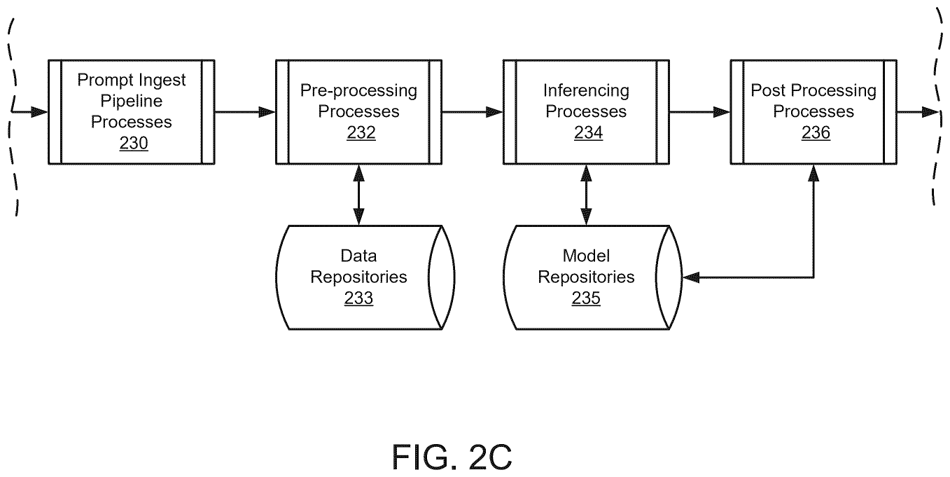

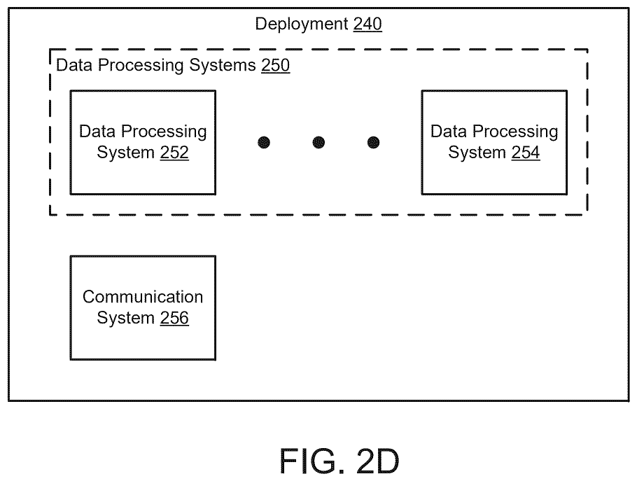

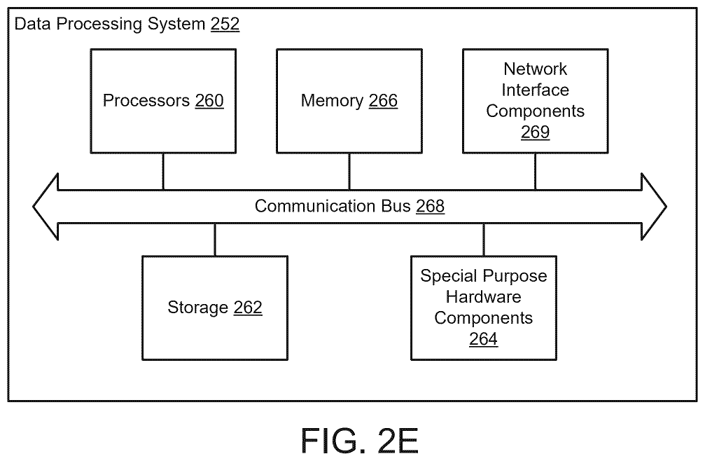

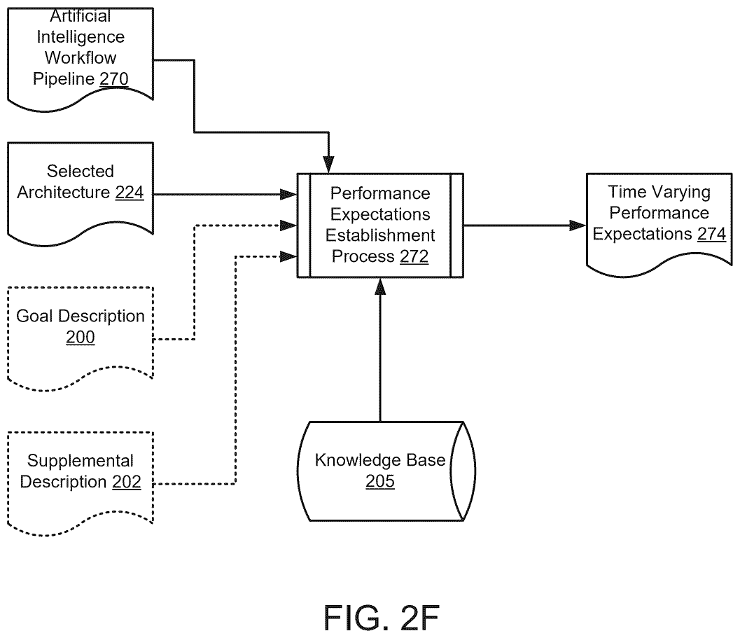

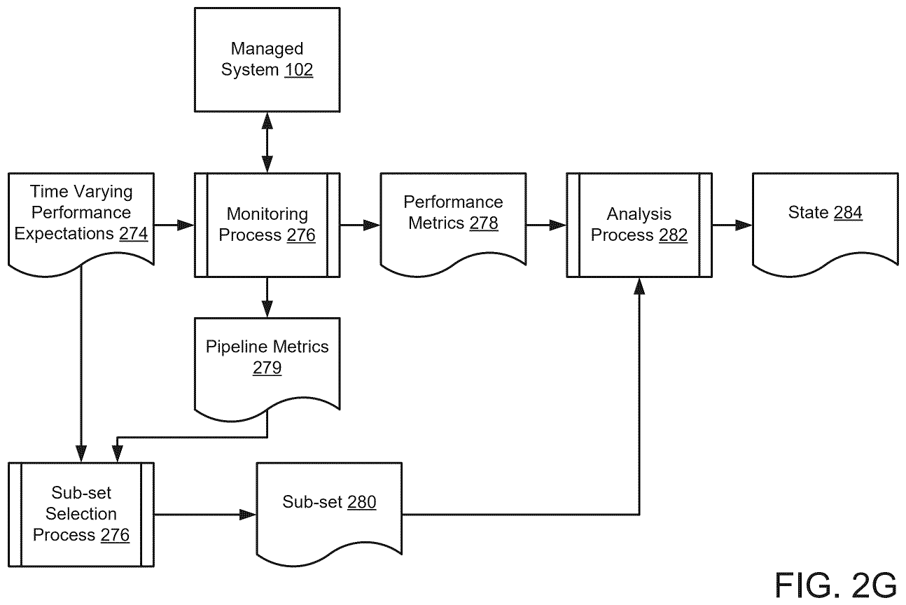

For example, management system 104 may identify a desirable artificial intelligence based processing architecture through which desired computer implemented services may be provided, identify hardware components to support the architecture, and manage deployment of the artificial intelligence based processing architecture and/or hardware components (and/or reallocation of existing components of managed system 102 to the artificial intelligence based processing services) to managed system 102. Refer to FIG. 2D-2E for additional details regarding artificial intelligence based processing architectures and/or how hardware components to support artificial intelligence based processing architectures may be selected for deployment.

Once the architecture and hardware components are identified and deployed, management system 104 may monitor operation of the deployed distributed system to identify whether it is performing as expected or performing undesirably (e.g., in an undesired state, such as unexpected operation of hardware/software, component failure/impairment, etc.). To ascertain the state of the system, management system 104 may monitor operation of the managed system to obtain performance metrics for the operation, and used the time varying performance expectations as a basis of comparison to ascertain whether the system is operating desirably. If operating undesirably, remedial action may be taken such as, for example, modifying operation of the managed system (e.g., to attempt to return the operation to a desired state), identify root causes for the undesired state of the operation, etc. Refer to FIGS. 2F-2G for additional information regarding manage operation of the managed system after the artificial intelligence workflow pipeline is deployed and in operation.

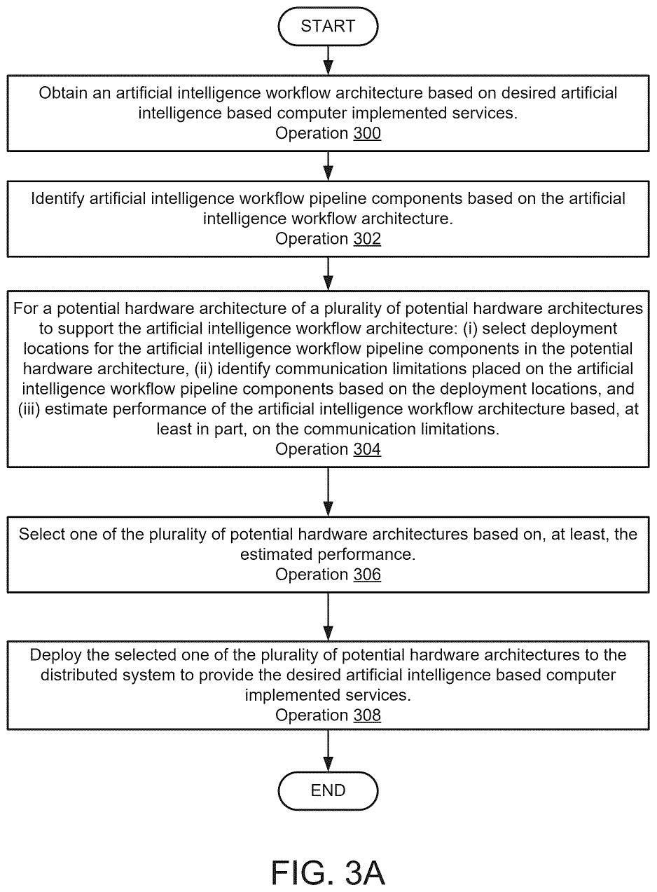

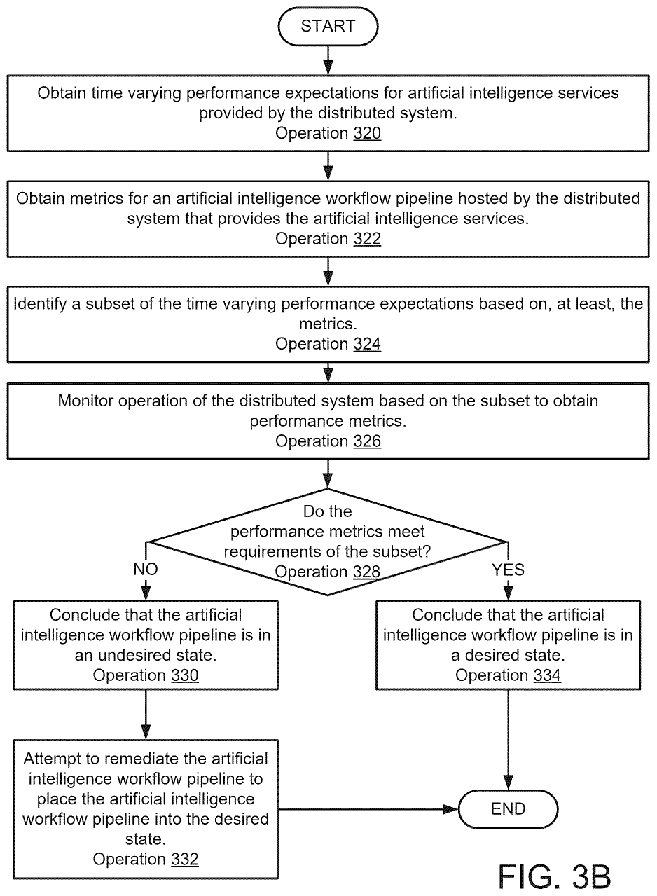

When providing their functionality, client devices 100, managed system 102, and/or management system 104 may perform all, or a portion, of the flows and/or methods shown in FIGS. 2A-2C and 2F-3B.

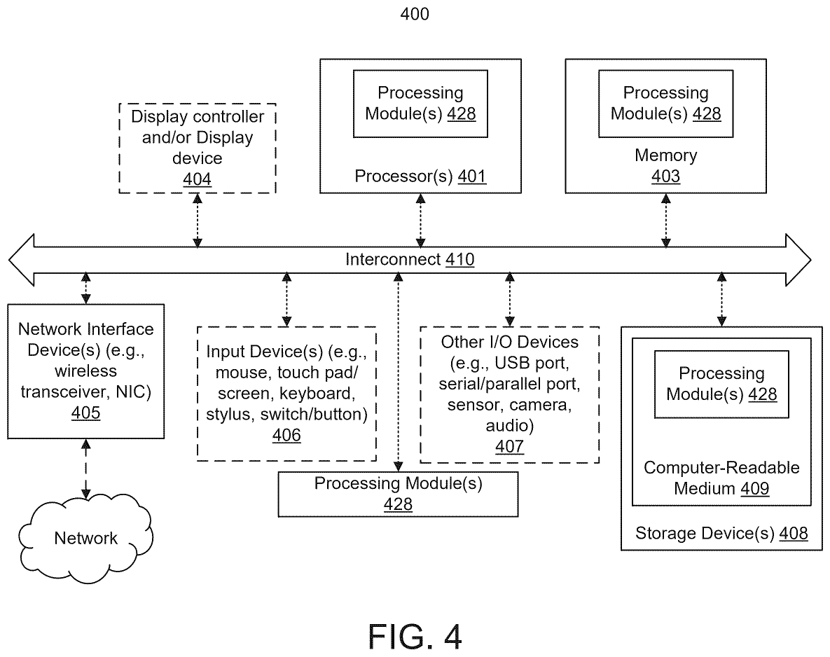

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with a communication system (e.g., 106) utilized by client devices 100, managed system 102, and/or management system 104 to, for example, cooperate with one another to facilitate the architectural regulation framework.

In an embodiment, this communication system includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C and 2F-2G. These data flow diagrams may illustrate how data may be obtained and used within the system of FIG. 1.

In the data flow diagrams, flows of data and processing of data are illustrated using different sets of shapes. In the context of these data flow diagrams, a first set of shapes (e.g., 200, 206, etc.) is used to represent data structures, a second set of shapes (e.g., 204, 220, etc.) is used to represent processes performed using and/or that generate data, and a third set of shapes (e.g., 205, 222, etc.) is used to represent large scale data structures such as databases.

Turning to FIG. 2A, a first data flow diagram in accordance with an embodiment is shown. The first data flow diagram may illustrate data used in and data processing performed in providing desired computer implemented services using managed system.

To provide the desired computer implemented services, information regarding desired services may be obtained. The information may take the form of, for example, responses to guided survey questions designed to elucidate desired uses for services to be provided by a managed system. The guided surveys may be presented via the portals, discussed above, and/or via other processes. Various users/administrators of an organization may provide responses via the guided surveys. The resulting aggregated information may be goal description 200.

In addition to goal description 200, other types of information may also be obtained. For example, existing uses of computer implemented services by the organization may be obtained. To do so, (i) information regarding the existing uses may be collected via survey, (ii) observability agents may be deployed to existing systems (e.g., client systems) to collect information regarding uses of existing systems/services, (iii) information regarding the field of operation of the organization may be collected and used as a basis for inferring various goals for desired services (e.g., an inference model such as a trained machine learning model may be used, the model may be trained based on historic information regarding organizations, actual desired uses for the to-be-provided services, and classifications for the organizations such as economic sector, organization size, etc.), and/or other types of information may be collected.

Once obtained, goal description 200 and supplemental description 202 may be ingested by goal analysis process 204. During goal analysis process 204, goal description 200 and/or supplemental description 202 may be analyzed based on knowledge base 205 to identify (i) use level 206, (ii) support level 208, and (iii) model level 210. Knowledge base 205 may include information regarding previously deployed and used artificial intelligence based processing architectures, and corresponding previously obtained goal descriptions and/or supplemental descriptions. Knowledge base 205 may be analyzed to identify a most similar goal description, supplemental description 202, and corresponding artificial intelligence based processing architecture. The corresponding artificial intelligence based processing architecture may be selected for use to provide the desired computer implemented services.

However, it will be appreciated that goal description 200 and supplemental description 202 may be significantly different from previously encountered goal descriptions and supplemental descriptions. In such scenarios, when the difference exceeds a threshold level, a subject matter expert may be used to define the artificial intelligence based processing architecture based on goal description 200 and supplemental description 202. Refer to FIG. 2C for additional information regarding artificial intelligence based processing architectures.

Returning to the discussion of FIG. 2A, once the artificial intelligence based processing architecture (e.g., an artificial intelligence workflow pipeline) is identified, the architecture may be analyzed to identify use level 206, support level 208, and model level 210.

Use level 206 may include information regarding a level of use expected for the artificial intelligence based processing architecture. Use level 206 may be used, for example, to identify how many instances of components of the artificial intelligence based processing architecture are to be instantiated to service the expected load on the service. Use level 206 may be identified, for example, by comparing an expected number of service requests per unit time (e.g., indicated by goal description 200) to typical service requests per unit time that can be achieved by the components of the artificial intelligence based processing architecture when deployed to typical hardware components (e.g., such information may be stored in knowledge base 205, and may be based on historic information from previously deployed artificial intelligence based processing architectures). The number of instances of each of the components may then be stored with use level 206, and used as a basis for analyzing the architectures for potential bottlenecks and/or other features.

Support level 208 may include information regarding services expected to be used to support the artificial intelligence services. The information may include, for example, numbers and types of such services which may include, for example, retrieval augmented generation, distillation, reinforced learning, etc. These services may support the generative or inferential services provided by a trained inference model (e.g., trained machine learning model) by, for example, enhancing prompts (e.g., retrieval augmented generation), customizing/refining models (e.g., reinforced learning, transfer learning, etc.), etc.

Model level 210 may include information regarding the type of model to be used in the artificial intelligence based processing architecture. For example, model level 210 may include information regarding the size of the model, complexity of revising the model, compatibility with other services (e.g., specified by support level 208), features of the architecture of the model (e.g., attention layers/other features), etc.

The aforementioned use level 206, support level 208, and model level 210 may be used to identify a hardware architecture to support the artificial intelligence based processing architecture, as discussed further with respect to FIG. 2B.

Knowledge base 205 may be implemented with a data repository, and may include any type and quantity information regarding any number of previously used artificial intelligence based processing architectures, artificial intelligence (AI) models, correspondingly performance of AI workloads by the models after deployment, information regarding development of the models (e.g., model training where training data is used to define model parameters, inferencing where a model ingests data and generates an output, model updating during which previously defined model parameters are updated based on new training data, etc.), information on which the artificial intelligence based processing architectures and/or models were selected (e.g., such as previously obtained goal descriptions, supplemental descriptions, etc.), and/or other types of information.

To differentiate information regarding the AI models, knowledge base 205 may be organized as, for example, a table including rows, each respective row corresponding to one of the AI models, architectures, and/or other type of structured data.

For example, each row may include information regarding a corresponding AI model, architecture, and/or references to other data structures that include information regarding the corresponding AI models/architectures. Further, the rows may be keyed to facilitate efficient searches for data regarding properties of the corresponding AI model/architecture, and basis (e.g., goal description/supplemental descriptions).

Turning to FIG. 2B, a second data flow diagram in accordance with an embodiment is shown. The second data flow diagram may illustrate data used in and data processing performed in deployment of an artificial intelligence based processing architecture.

To deploy the artificial intelligence based processing architecture, use level 206, support level 208, and model level 210 may be ingested by architecture selection process 220 and through which a selected architecture 224 may be identified. During architecture selection process 220, various hardware components to support the artificial intelligence based processing architecture identified via the flow shown in FIG. 2A may be identified and selected.

To identify and select the components, use level 206 and model level 210 may be used to select a number of candidate hardware components from architecture repository 222. Architecture repository 222 may include information regarding various hardware components that may be used to host an artificial intelligence based processing architecture. Generally, the hardware components may include processors, memory devices, storage devices, special purposes hardware components (e.g., graphics processing units, data processing units, etc.), communication devices (e.g., network interface cards, communication buses, etc.), and/or other types of hardware components (e.g., such as interconnect components like motherboards). Each of the components may be rated in architecture repository 222 with respect to an ability to serve as a host for a component of the artificial intelligence based processing architecture. For example, each hardware component may be rated with respect to the type of component of the artificial intelligence based processing architecture that it may support, the processing capabilities (e.g., throughput), and/or other characteristics that may be used to select a hardware component.

It will be appreciated that architecture repository 222 may include similar information for various aggregations of hardware components such as at a server level, a rack level, an aisle level (e.g., multiple racks), etc. may also be included in architecture repository 222. Thus, in some cases, architecture repository 222 may include information regarding select potential aggregate options.

Based on the information in architecture repository 222, a number of candidate hardware components may be identified to support the artificial intelligence based processing architecture. Refer to FIGS. 2D-2E for additional information regarding hardware components that may support artificial intelligence based processing architectures.

Once the candidate hardware components are identified, the candidate hardware components may be analyzed based on support level 208 to identify (i) placements of components of the artificial intelligence based processing architecture with the candidate hardware components (e.g., may be made based on subject matter expert rules, or other types of rules), and (ii) any communication bottlenecks present in the candidate hardware components that may prevent the corresponding candidate hardware components from providing the processing throughput as indicated by the information in architecture repository 222.

To identify the communication bottlenecks, any process may be performed. For example, subject matter expert rules may be used to analyze the hardware components for such communication bottlenecks, testing of similar hardware components with test workloads may be performed to obtain workload results, etc.

For example, to actively test for communication bottlenecks, test workloads that are representative of the expected use of the artificial intelligence based processing architecture may be deployed to a test hardware setup which may be similar to the candidate hardware components. When deployed, the actual operation of the test workloads may be monitored to identify whether performance of the test workloads meets expectations based on the information included in architecture repository 222. If a deviation from the expected performance is identified, then the candidate hardware component may be removed from consideration. The aforementioned process may be repeated until all deviating hardware components are removed from the candidate hardware components. The remaining candidate hardware components may then be used as a basis for selected architecture 224.

For example, selected architecture 224 may be a list of the numbers and types of the candidate hardware components, the components of the artificial intelligence based processing architecture and placement information with respect to the hardware components, etc. It will be appreciated that selected architecture 224 may include additional, less, and/or different information.

Once selected architecture 224 is obtained, then the artificial intelligence based processing architecture may be deployed to a managed system. As part of the deployment, existing hardware components (that are not yet allocated) of managed system meeting the requirements of selected architecture 224 may be allocated for the artificial intelligence based processing architecture, new hardware components may be added to the managed system, and components of the artificial intelligence based processing architecture may be instantiated on the allocated hardware components of the managed system.

Once instantiated, the artificial intelligence based processing architecture may begin to operate to provide desired computer implemented services. Refer to FIG. 2C for additional information regarding artificial intelligence based processing architectures.

Turning to FIG. 2C, a third data flow diagram in accordance with an embodiment is shown. The third data flow diagram may illustrate data used in and data processing performed in operation of an artificial intelligence based processing architecture.

To operation the artificial intelligence based processing architecture, various components of the artificial intelligence based processing architecture may be deployed to various hardware components allocated for the artificial intelligence based processing architecture.

For example, the artificial intelligence based processing architecture may include various processes (e.g., 230, 232, 234, 236) for providing artificial intelligence based processing services. However, it will be appreciated that the processes shown in FIG. 2C are just an example and other artificial intelligence based processing architectures may include other types of processes.

Generally, the artificial intelligence based processing architecture may include at least one prompt ingest pipeline processes 230. During prompt ingest pipeline processes 230, prompts for an artificial intelligence model may be obtained and/or partially pre-processed based on various rules for prompts.

Once obtained, the prompts (as processed) may be subjected to various pre-processing processes 232 such as retrieval augmented generation, templating, etc. During such pre-processing processes, information from various data repositories 233 may be obtained and used as context for the prompt. Likewise, various templates for the prompts may be obtained and populated.

It will be appreciated that data repositories 233 may generally be stored in storage, and pre-processing processes 232 may be executing on processors. Depending on the topology of the communication system interconnecting these hardware components, the communication system may limit the ability of the hosted components to efficiently utilize the host hardware components. For example, communication bottlenecks may limit the ability of information to be retrieved from data repositories 233 and vetted for use as context for the prompt, even though neither hardware component hosting the architecture component (e.g.., 232, 233) is limiting activity of the hosted architecture component. Thus, a first example communication bottleneck that may impact operation of the artificial intelligence based processing architecture is illustrated.

Once pre-processed, the prompt may be submitted to inferencing processes 234, and used as an input to a trained model from model repositories 235. The model may be any type of trained machine learning model. Like pre-processing processes 232 and data repositories 233, communication bottlenecks between inferencing processes 234, model repositories 235, and the other components of the artificial intelligence based processing architecture may artificially limit the rate of operation of inferencing processes 234.

Once an inference is obtained based on the prompt, post processing processes 236 may be performed. Post processing processes 236 may include, for example, reinforced learning, rule application (e.g., screening inferences), and/or other processes to obtain a final response to the prompt and/or update operation of the artificial intelligence based processing architecture. Again, like the other components of the artificial intelligence based processing architecture, the throughput of post processing processes 236 may be artificially limited due to communication bottlenecks.

To avoid such limits, the communication capabilities of the candidate hardware components may be analyzed, as discussed above, and serve as a basis for exclusion. To further explain such limits, example diagrams of a potential deployment 240 in accordance with an embodiment are shown in FIGS. 2D-2E.

Turning to FIG. 2F, a fourth data flow diagram in accordance with an embodiment is shown. The fourth data flow diagram may illustrate data used in and data processing performed in establishing performance expectations for artificial intelligence workflow pipelines.

To establish the performance expectations, information regarding (i) the artificial intelligence workflow pipeline 270 (e.g., may specify components of an artificial intelligence based processing architecture), (ii) supporting hardware components (e.g., that host an instance of the artificial intelligence based processing architecture), and (iii) desired services to be provided using the artificial intelligence workflow pipeline and the supporting hardware may be analyzed. For example, during performance expectations establishment process 272, any of artificial intelligence workflow pipeline 270, selected architecture 224, goal description 200, and supplemental description 202 may be ingested and used to generate time varying performance expectations 274.

Time varying performance expectations 274 may include criteria for identifying an operational state of an artificial intelligence workflow pipeline and/or supporting hardware. For example, time varying performance expectations 274 may indicate performance requirements for the operation of the artificial intelligence workflow pipeline and/or supporting hardware. These performance requirements may specify, for example, (i) throughput rates for provided services (e.g., inferences per unit time, training cycles per unit time, etc.), (ii) quality expectations (e.g., accuracy, precision, recall, F1 score, area under receiver operating characteristic curve, various regression metrics such as root mean square error, etc.) for the provided services, (iii) efficiency expectations (e.g., power consumption per provided service), and/or other types of expectations.

Time varying performance expectations 274 may include various subsets of the time varying performance requirements. These different subsets may be associated with (i) different points in time measured from when service provisioning is initiated, and/or (ii) different metrics (e.g., model size, rates at which support services for the artificial intelligence based processing services are provided, etc.) regarding the artificial intelligence workflow pipeline. When initially established, the artificial intelligence workflow pipeline and/or supporting hardware may be in an initial state. Consequently, an initial subset of performance expectations may be established using knowledge base 205 (e.g., which may include information regarding performance of services provided by similar pipelines and support hardware).

However, over time this initial state may change due to, for example, changes to models, types of services provided, changes (e.g., degradation/failure) in operation of the hardware components, etc. To take these changes into account, additional subsets may be generated. These additional subsets may take into account (i) estimated changes in performance of the hardware components over time, and (ii) changes in performance of the services due to the changes in the artificial intelligence workflow pipeline. The estimated changes in performance of the hardware components may be based on statistical analysis of such components. The changes in performance of the services may be estimated based on changes in resources required to operate portions of the artificial intelligence workflow pipeline. For example, when initially established an artificial intelligence workflow pipeline may include a model of a particular size. Overtime the model may increase (or decrease) in size resulting in operation of the model consuming additional resources of the host hardware components. Estimates for different model sizes (e.g., a metric of an artificial intelligence workflow pipeline), different support service availabilities (e.g., another metric for artificial intelligence workflow pipeline such as retrieval augmented generation being less/more available), etc. Any number of such subsets may be generated, which may correspond to any number of different points in time (e.g., from onset of provisioning of services) and metrics (e.g., different model sizes, different support service availabilities, etc.).

To obtain time varying performance expectations 274, a templating process or other process may be used. For example, a template may be populated using the ingested information, and/or information from knowledge base 205.

As an example, due to likely reductions in capabilities of the hardware components and increasing resource costs for operating components of artificial intelligence workflow pipelines, the time varying performance expectations may generally indicate reduced requirements as time increases. Consequently, any reduction in performance of the services may not be treated as an issue due to the artificial intelligence workflow pipeline and/or supporting hardware.

For example, a time varying performance expectations for a given system may include five subsets of performance requirements. A first subset may be associated with a first point in time, a second subset may be associated with a second point in time and first metrics for the artificial intelligence workflow pipeline, a third subset may be associated with the second point in time and second metrics for the artificial intelligence workflow pipeline, a fourth subset may be associated with a third point in time and the first metrics for the artificial intelligence workflow pipeline, a fifth subset may be associated with the third point in time and the second metrics for the artificial intelligence workflow pipeline. To identify the subset to use, the current time and actual metrics of an artificial intelligence workflow pipeline may be used to discriminate down to a subset. The discriminated subset may specify requirements for the operation and services.

Once obtained, time varying performance expectations 274 may be used to characterize the operating state of the artificial intelligence workflow pipeline and support hardware, as further discussed with respect to FIG. 2G.

Turning to FIG. 2G, a fifth data flow diagram in accordance with an embodiment is shown. The fifth data flow diagram may illustrate data used in and data processing performed in managing operation of artificial intelligence workflow pipelines and supporting hardware components.

To manage the operation, monitoring process 276 may be performed. During monitoring process 276, operation of managed system 102 may be monitored to obtain performance metrics 278 and characteristics of an artificial intelligence workflow pipeline hosted by hardware of managed system 102 may be identified to obtain pipeline metrics 279.

The operation of managed system 102 may be monitored based on the requirements specified by time varying performance expectations 274 (e.g., each subset of time varying performance expectations 274 may indicate characteristics of the operation to monitor, such as throughput rate, and corresponding requirements for the characteristics).

The characteristics of the artificial intelligence workflow pipeline may be identified by, for example, reading them from storage, obtaining them from another device, measuring/requesting them from managed system 102, and/or via other methods. The characteristics may be stored as pipeline metrics 279. For example, pipeline metrics 279 may include characteristics such as model size, model type, support services, etc. As noted with respect to FIG. 2F, these pipeline metrics 279 (in combination with a current time) may be used to discriminate a subset 280 of the subsets of the time varying performance expectations 274.

For example, subset selection process 276 may be performed to identify subset 280. During subset selection process the current time (or elapsed time from when the services are initially provided by managed system 102) and/or the pipeline metrics (e.g., 279) may be used to discriminate one of the subsets (e.g., 280).

Once subset 280 is identified and performance metrics 278 are obtained, analysis process 282 may be performed. During analysis process 282, Performance metrics 278 may be compared to the requirements specified by subset 280. An operating state 284 for the artificial intelligence workflow pipeline may be identified based on the comparison.

For example, if performance metrics 278 meet or exceed the requirements, then state 284 may be concluded to be a desired state. In contrast, if not all of performance metrics 278 meet or exceed the requirements, then state 284 may be concluded to be an undesired state (e.g., meaning that the artificial intelligence workflow pipeline is not performing nominally, and is likely being impacted by an issue that should be addressed).

In the event that state 284 is undesirable, then an attempt to remediate the artificial intelligence workflow pipeline may be made. During the attempt, for example, diagnostic information for the artificial intelligence workflow pipeline and supporting hardware may be collected and compared to similar diagnostic information from other artificial intelligence workflow pipelines that are known to be in desired and/or undesired states. Various actions used to address issuing impacting artificial intelligence workflow pipelines that provided similar diagnostic data may be identified and used to attempt to fix the artificial intelligence workflow pipeline.

The flow may then return to monitoring process 276 to identify whether the attempted remediation was successful.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2D, a block diagram of an example deployment 240 in accordance with an embodiment is shown. Deployment 240 may include any number of data processing systems 250. The data processing systems (e.g., 252, 254) may be connected to each other via communication system 256.

Data processing systems 250 may include hardware components that may host components of an artificial intelligence based processing architecture. Refer to FIG. 2E for additional details regarding potential hardware components of a data processing system.

Data processing systems 250 may be operably connected via communication system 256. Communication system 256 may include various communication components such as a switches, routers, etc. These communication components may enable the data processing systems to communicate with one another. Because the artificial intelligence based processing architecture may be distributed across data processing system 250, the communication limits imposed by communication system 256 may limit operation of the hardware components of data processing systems 250 supporting the artificial intelligence based processing architecture.

For example, if some data processing systems (e.g., 254) serve as storage repositories for retrieval augmented generation, but other data processing systems (e.g., 252) process prompts, then the ability of information necessary to provide context for the prompts to be collected may be by communication system 256 rather than the data processing systems themselves. Accordingly, as described, inter-device communication limits may prevent expected operation of artificial intelligence based processing architectures for the given available hardware components.

Turning to FIG. 2E, a block diagram of an example data processing system 252 in accordance with an embodiment is shown. Any of data processing systems 250 may be similar to data processing system 252.

To support operation of the artificial intelligence based processing architecture, data processing system 252 may include various hardware components such as processors 260 (e.g., central processing units), storage 262 (e.g., storage devices, controllers, etc.), memory 266 (e.g., memory modules, transitory), and special purpose hardware components 264 (e.g., graphics/data processing units). The hardware components may be operably connected to each other via a communication bus (e.g., 268), point to point communication links, and/or other communication architectures. Additionally, the hardware components may include a network interface component (e.g., 269, a network interface card, etc.) to enable communications to be routed to other data processing systems.

To support the artificial intelligence based processing architecture, various components of the artificial intelligence based processing architecture may be hosted by the hardware components. For example, trained machine learning models, training programs, etc. may be hosted by special purpose hardware components 264, while processors 260 may host various pre and post processing components of the artificial intelligence based processing architecture. Likewise, storage 262 may host various data structures (e.g., repositories of information) used in the processing such as trained machine learning model copies, repositories of contextual information for prompt enhancement, etc.

The operation of any of these hardware components may be limited due to the communication components supporting their operation. For example, if processors 260 host a pre-processing components such as a retrieval augmented generation process that utilizes contextual information hosted by storage 262, communication bus 268 may limit the rate at which the information may be retrieved should the communication bus be saturated with other traffic (e.g., such as when loading trained machine learning models into special purpose hardware components, transferring context information to other data processing systems, etc.). Accordingly, as described, intra-device communication limits may prevent expected operation of artificial intelligence based processing architectures for the given available hardware components.

To manage these limits, as discussed above, hardware components may be selected, at least, on this basis to prevent them from negatively impacting operation of the artificial intelligence based processing architecture.

While illustrated in FIG. 2E with an example set of hardware components, a data processing system may include fewer, different, and/or additional hardware components without departing from embodiments disclosed herein.

As discussed above, the components of FIG. 1 may perform various methods to manage the operation of managed systems to provide desired computer implemented services. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing operation of a managed system in accordance with an embodiment is shown. The method may be performed by any of the components of the system of FIG. 1.

At operation 300, an artificial intelligence workflow architecture that is based on desired artificial intelligence based computer implemented services is obtained. The artificial intelligence workflow architecture may be obtained by obtaining information regarding the desired artificial intelligence based computer implemented services (e.g., via a portal or other interface) and using the information to identify the artificial intelligence workflow architecture. For example, historic information regarding previously deployed artificial intelligence workflow architectures and desired artificial intelligence based computer implemented services (on which the architectures were based) may be used to identify the artificial intelligence workflow architecture.

Once identified, use levels, support levels, and model levels may be identified based on the artificial intelligence workflow architecture and/or the information regarding the desired use of the artificial intelligence based computer implemented services. The aforementioned levels may be identified, for example, based on historic information, based on analytical models regarding such use, support, and models, and/or via other methods (e.g., trained inference models may be used).

At operation 302, artificial intelligence workflow pipeline components may be identified based on the artificial intelligence workflow architecture. The types of the artificial intelligence workflow pipeline components may be identified, for example, based on the support level and model level. The number of each type may be selected based on the use level for the artificial intelligence based computer implemented services.

For example, to identify the components, a use level for the desired artificial intelligence based computer implemented services, a support level for the desired artificial intelligence based computer implemented services, and a model level for the desired artificial intelligence based computer implemented services may be identified.

The use level may be a quantification of, at least, an expected frequency of use of the desired artificial intelligence based computer implemented services.

The support level may be based on services (e.g., prompt templating, retrieval augmented generation, reinforced learning, model distillation, etc.) that will support operation of an inferencing component of the artificial intelligence workflow architecture.

The model level may be a quantification of a size of an inferencing component of the artificial intelligence workflow architecture.

At operation 304, for a potential hardware architecture of a plurality of potential hardware architectures to support the artificial intelligence workflow architecture: (i) deployment locations for the artificial intelligence workflow pipeline components in the potential hardware architecture may be selected, (ii) communication limitations placed on the artificial intelligence workflow pipeline components based on the deployment locations may be identified, and (iii) performance of the artificial intelligence workflow architecture may be estimated based, at least in part, on the communication limitations

The deployment locations may be selected based on, for example, subject matter expert rules, historic information regarding previously deployed artificial intelligence workflow architectures, and/or other methods.

The communication limits may be identified by, for a data processing system of the potential hardware architecture: identifying a communication bus connecting a processor of the data processing system serving as a first deployment location of the deployment locations, a storage device serving as a second deployment location of the deployment locations, and a special purpose hardware component serving as a third deployment location of the deployment locations; and estimating limits imposed on operation of a portion of the artificial intelligence workflow pipeline components when positioned at the first deployment location, the second deployment location, and the third deployment location.

The limits imposed on operation of a portion of the artificial intelligence workflow pipeline components may be estimated by (i) applying subject matter expert defined rules, (ii) using analytical approaches, and/or (iii) via testing through test workload deployment to similar systems. The limits may be reductions in the throughput rates of the portion of the artificial intelligence workflow pipeline components from a nominal rate based on the host hardware.

The performance of the artificial intelligence workflow architecture based, at least in part, on the communication limitations may be estimated using analytical approaches, subject matter expert defined rules, testing of similar systems (e.g., active or historical), and/or via other methods.

The aforementioned process may be repeated for any number of potential hardware architectures to discriminate acceptable from unacceptable hardware architectures. In other words, potential hardware architectures that are estimated to have reduced performance may be eliminated as candidates, and/or the potential hardware architectures may be rank ordered based on the estimated performance.

At operation 306, one of the plurality of potential hardware architectures may be selected based on, at least, the estimated performance. The best ranked potential hardware architecture may be selected.

At operation 308, the selected one of the plurality of potential hardware architectures may be deployed to the distributed system to provide the desired artificial intelligence based computer implemented services. The selected one may be deployed by (i) allocating existing components of the distributed system for the desired artificial intelligence based computer implemented services, (ii) adding and allocating new components to the distributed system for the desired artificial intelligence based computer implemented services, and (iii) instantiating the components of the artificial intelligence workflow pipeline components to the allocated components of the distributed system.

The method may end following operation 308.

Turning to FIG. 3B, a second flow diagram illustrating a method for managing operation of a managed system in accordance with an embodiment is shown. The method may be performed by any of the components of the system of FIG. 1.

At operation 320, time varying performance expectations for artificial intelligence services provided by a distributed system are obtained. The distributed system may be a managed system. The artificial intelligence services may be provided using an artificial intelligence workflow pipeline hosted by hardware.

The time varying performance expectations may be obtained by reading them from storage, receiving them from another device, generating them, and/or via other methods.

As discussed above, the time varying performance expectations may include any number of subsets of requirements associated with different points in time and/or metrics regarding the artificial intelligence workflow architecture.

At operation 322, metrics for the artificial intelligence workflow pipeline hosted by the distributed service and that provides artificial intelligence services are obtained. The metrics may be obtained by reading them from storage, receiving them from another device, reading them from the managed system, and/or via other methods. The metrics may be pipeline metrics, as discussed above, and may relate to characteristics of the artificial intelligence workflow pipeline (e.g., an example shown in FIG. 2C).

At operation 324, a subset of time varying performance expectations are identified based on at least the metrics. The subset may be identified using the metrics and/or other information (e.g., time) to discriminate the subset from other subsets of the time varying performance expectations. The identified subset may indicate requirements.

At operation 326, operation of the distributed system may be monitored based on the subset to obtain performance metrics. The operation may be monitored by requesting information regarding the operation from the distributed system and receiving information regarding the operation from the distributed system. The request may indicate quantities to be monitored.

At operation 328, a determination is made regarding whether the performance metrics meet the requirements of the subset. The determination may be made by comparing the performance metrics to the requirements. The requirements may specify, for example, minimum acceptable performance for each of the performance metrics.

If the performance metrics meet the requirements, then the method may proceed to operation 334. If the performance metrics do not meet the requirements, then the method may proceed to operation 330.

At operation 330, it may be concluded that the artificial intelligence workflow pipeline is in an undesired state.

At operation 332, an attempt to remediate the artificial intelligence workflow pipeline to place the artificial intelligence workflow pipeline into the desired state may be made. The attempt may be made, for example, by attempt to identify a root cause by comparing the operation of the artificial intelligence workflow pipeline to operation of similar artificial intelligence workflow pipeline to identify deviations (e.g., which may indicate issues). Then any number of actions may be performed to attempt to remediate any indicated issues. The actions may include, for example, monitoring configurations of the artificial intelligence workflow pipeline, modifying components of the artificial intelligence workflow pipeline, and/or other actions that may modify the operation of the artificial intelligence workflow pipeline.

The method may end following operation 332.

Returning to operation 328, the method may proceed to operation 334 when the performance metrics do not meet the requirements.

At operation 334, it may be concluded that the artificial intelligence workflow pipeline is in a desired state.

The method may end following operation 334.

Thus, using the methods shown in FIGS. 3A-3B, embodiments disclosed herein may facilitate deployment of artificial intelligence workflow pipelines and monitoring of the deployed artificial intelligence workflow pipelines in a manner that is less likely to falsely that the artificial intelligence workflow pipelines are operating undesirably.

Any of the components illustrated in FIGS. 1-2G may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
obtaining time varying performance expectations for artificial intelligence services provided by the distributed system;
obtaining metrics for an artificial intelligence workflow pipeline hosted by the distributed system that provides the artificial intelligence services;
identifying a subset of the time varying performance expectations based on, at least, the metrics;
monitoring operation of the distributed system based on the subset to obtain performance metrics;
making a determination regarding whether the performance metrics meet requirements of the subset of the time varying performance expectations;
in a first instance of the determination where the performance metrics do not meet the requirements of the subset of the time varying performance expectations:
concluding that the artificial intelligence workflow pipeline is in an undesired state; and
in a second instance of the determination where the performance metrics meet the requirements of the subset of the time varying performance expectations:
concluding that the artificial intelligence workflow pipeline is in a desired state and continuing provisioning of the artificial intelligence services using the artificial intelligence workflow pipeline.

2. The method of claim 1, wherein the subset are indicated by the time varying performance expectations.

3. The method of claim 2, wherein at least one of the subset is a quantification of a rate at which the artificial intelligence workflow pipeline services requests.

4. The method of claim 2, wherein at least one of the subset is a quantification of a rate at which a support service for the artificial intelligence workflow pipeline services requests.

5. The method of claim 1, further comprising:
based on concluding that the artificial intelligence workflow pipeline is in an undesired state:
attempting to remediate the artificial intelligence workflow pipeline to place the artificial intelligence workflow pipeline into the desired state.

6. The method of claim 1, wherein the time varying performance expectations comprise multiple subsets that are each associated with different points in time.

7. The method of claim 6, wherein the multiple subsets indicate progressively relaxed requirements over time.

8. The method of claim 7, wherein the different points in time are measured with reference to an initiation of provisioning of the artificial intelligence services by the distributed system.

9. The method of claim 1, wherein the metrics for the artificial intelligence workflow pipeline comprise:
a size of a trained machine learning model of the artificial intelligence workflow pipeline; and
a quantity of training data used in training of the trained machine learning model.

10. The method of claim 9, wherein the requirements vary, at least in part, based on the metrics.

11. A non-transitory machine-readable medium having instructions stored therein, which when executed by a processor, cause operations for managing a distributed system to be performed, the operations comprising:
obtaining time varying performance expectations for artificial intelligence services provided by the distributed system;
obtaining metrics for an artificial intelligence workflow pipeline hosted by the distributed system that provides the artificial intelligence services;
identifying a subset of the time varying performance expectations based on, at least, the metrics;
monitoring operation of the distributed system based on the subset to obtain performance metrics;
making a determination regarding whether the performance metrics meet requirements of the subset of the time varying performance expectations;
in a first instance of the determination where the performance metrics do not meet the requirements of the subset of the time varying performance expectations:
concluding that the artificial intelligence workflow pipeline is in an undesired state; and
in a second instance of the determination where the performance metrics meet the requirements of the subset of the time varying performance expectations:
concluding that the artificial intelligence workflow pipeline is in a desired state and continuing provisioning of the artificial intelligence services using the artificial intelligence workflow pipeline.

12. The non-transitory machine-readable medium of claim 11, wherein the subset is indicated by the time varying performance expectations.

13. The non-transitory machine-readable medium of claim 12, wherein at least one of the subset is a quantification of a rate at which the artificial intelligence workflow pipeline services requests.

14. The non-transitory machine-readable medium of claim 12, wherein at least one of the subset is a quantification of a rate at which a support service for the artificial intelligence workflow pipeline services requests.

15. The non-transitory machine-readable medium of claim 11, wherein the operations further comprise:
based on concluding that the artificial intelligence workflow pipeline is in an undesired state:
attempting to remediate the artificial intelligence workflow pipeline to place the artificial intelligence workflow pipeline into the desired state.

16. A data processing system, comprising:
a processor; and
a memory coupled to the processor to store instructions, which when executed by the processor, cause operations for managing a distributed system to be performed, the operations comprising:
obtaining time varying performance expectations for artificial intelligence services provided by the distributed system;
obtaining metrics for an artificial intelligence workflow pipeline hosted by the distributed system that provides the artificial intelligence services;
identifying a subset of the time varying performance expectations based on, at least, the metrics;
monitoring operation of the distributed system based on the subset to obtain performance metrics;
making a determination regarding whether the performance metrics meet requirements of the subset of the time varying performance expectations;
in a first instance of the determination where the performance metrics do not meet the requirements of the subset of the time varying performance expectations:
concluding that the artificial intelligence workflow pipeline is in an undesired state; and
in a second instance of the determination where the performance metrics meet the requirements of the subset of the time varying performance expectations:
concluding that the artificial intelligence workflow pipeline is in a desired state and continuing provisioning of the artificial intelligence services using the artificial intelligence workflow pipeline.

17. The data processing system of claim 16, wherein the subset is indicated by the time varying performance expectations.

18. The data processing system of claim 17, wherein at least one of the subset is a quantification of a rate at which the artificial intelligence workflow pipeline services requests.

19. The data processing system of claim 17, wherein at least one of the subset is a quantification of a rate at which a support service for the artificial intelligence workflow pipeline services requests.

20. The data processing system of claim 16, wherein the operations further comprise:
based on concluding that the artificial intelligence workflow pipeline is in an undesired state:
attempting to remediate the artificial intelligence workflow pipeline to place the artificial intelligence workflow pipeline into the desired state.
